(19) United States
(12) Patent Application Publication
(10) Pub. No.: US 2009/0238944 A1
(43) Pub. Date: Sep. 24, 2009

(54) Allergen Reduction Method, Method of Producing Allergen-reduced Albumen, Method of Producing Allergen-reduced Albumen Composition, and Allergen-reduced Food Product

(76) Inventor: Kyoko Takahashi, Osaka (JP)

Correspondence Address: BIRCH STEWART KOLASCH & BIRCH, PO BOX 747, FALLS CHURCH, VA, 22040-0747, US

(21) Appl. No.: 12/475,972

(22) Filed: Jun. 1, 2009

Related U.S. Application Data
(62) Division of application No. 11/519,783, filed on Sep. 13, 2006.

(30) Foreign Application Priority Data
Mar. 29, 2006 (JP) 2006-091526 (P)

(51) Int. Cl. A23L 1/32

(52) U.S. Cl. 426/614

(57) ABSTRACT

It is aimed to provide an allergen reduction method which can be carried out without the need for a large or complicated apparatus and which allows an allergen content to be reduced while maintaining basic characteristics intrinsic to albumen, such as texture, foaming property, and foam stability, a method of producing allergen-reduced albumen, a method of producing an allergen-reduced albumen composition, and an allergen-reduced food product. The present invention relates to an allergen reduction method to reduce a content of an allergen in albumen by a heating and pressurizing treatment with a treatment pressure set in a range of 140 to 400 kPa and a treatment temperature set in a range of 110 to 150° C., a method of producing allergen-reduced albumen, a method of producing an allergen-reduced albumen composition, and an allergen-reduced food product.

### CROSS-REFERENCE TO RELATED APPLICATIONS

The present application is a 37 C.F.R. § 1.53(b) divisional of U.S. application Ser. No. 11/519,783 filed Sep. 13, 2006, which in turn claims priority on Japanese Application No. 2006-091526 filed Mar. 29, 2006. The entire contents of each of these applications is hereby incorporated by reference.

### BACKGROUND OF THE INVENTION

1. Field of the Invention

The present invention relates to an allergen reduction method to reduce the likelihood of triggering allergic symptoms by reducing an allergen content in albumen, a method of producing allergen-reduced albumen with the reduced allergen content, a method of producing an allergen-reduced albumen composition with the reduced allergen content, and an allergen-reduced food product, which is a food product containing the allergen-reduced albumen or a food product made of the allergen-reduced albumen composition.

2. Description of the Background Art

Recently, patients who exhibit immediate reactions of food allergies have significantly been increasing, which develops into a social problem. Among others, infant egg allergy caused by an IgE antibody is a major concern. It has already been found out that the main cause of the egg allergy is a particular protein such as ovalbumin or ovomucoid included in albumen. Since ovalbumin denatures, for example, by a heating treatment at about 80-100° C., the allergic reaction caused by the ovalbumin can be avoided by taking in heated albumen. On the other hand, it is known that ovomucoid is heat-resistant and less digestible and hardly denatures. The heat-resistance and low digestibility of ovomucoid results from a strong protein structure formed of oligosaccharide in the molecule.

It has already been reported that when ovomucoid is boiled for 30 minutes or longer at about 100° C., the tertiary structures of the ovomucoid partially degenerate. However, there are several epitope portions of ovomucoid recognized by IgE antibody, so that even if the tertiary structures of part of epitope portions degenerate, the allergenicity of ovomucoid is maintained by the remaining epitope portions.

Japanese Patent Laying-Open No. 61-015644 proposes a method in which albumen liquid is adjusted at a pH 1 to 6 and thereafter heated at 60 to 90° C., and the produced gel-like precipitate is dissolved again at a pH 7 to 10 and then dried. Furthermore, Japanese Patent Laying-Open No. 2004-261154 proposes a method in which albumen aqueous solution adjusted at pH 10-11.5 is heated at 80° C. or higher. However, according to Japanese Patent Laying-Open Nos. 61-015644 and 2004-261154, albumen liquid is treated under an acid or alkaline condition, and thus in the treated albumen, the protein molecule other than the allergen excessively degenerates. When the protein molecule other than the allergen excessively degenerates in albumen, disadvantageously, a food product using that albumen does not provide basic characteristics intrinsic to albumen, such as good texture, a foaming property, and foam stability.

Japanese Patent Laying-Open No. 07-236454 proposes a method in which albumen liquid is heated and coagulated, then ground, and then washed. In this technique, ovomucoid included in the heated and coagulated albumen is removed by washing, resulting in allergen-reduced albumen. Furthermore, Japanese Patent Laying-Open No. 11-046721 proposes a method in which a protein and a food material including the same are mixed or kneaded with flour and then baked. This technique results in a food product including ovomucoid with reduced allergenicity. However, with these techniques, it is difficult to reduce allergen sufficiently.

On the other hand, “The Influence to the Decrease of Antigen Ovomucoid in Egg White by the Processing Operation”, Bulletin Mukogawa Women's University Nature Science, 50, 103-107 (2002) proposes a method of reducing an allergen in albumen in which a dry albumen solution or a dry albumen mixed solution including the dry albumen solution mixed with milk or flour is subjected to a steam treatment for 30 minutes on a boiling bath or a dry heat treatment in an oven at 170° C. for 30 minutes. However, the steam treatment as described above hardly provides sufficient allergen reduction. On the other hand, the dry heat treatment as described above causes excessive thermal denaturation in the protein molecule other than the allergen in albumen and does not provide the basic characteristics intrinsic to albumen, such as good texture, the foaming property, and foam stability when the albumen is used in a food product.

According to “The Influence to the Decrease of Antigen Ovomucoid in Egg White by the Processing Operation”, Bulletin Mukogawa Women's University Nature Science, 50, 103-107 (2002), an extremely high pressure treatment is additionally performed on the above-noted dry albumen solution or the above-noted dry albumen mixed solution at a pressure of 686 MPa, at room temperature for 30 minutes. It is generally known that the high-order structure of protein denatures by a heating treatment or a high pressure treatment. Thus, the method described above may achieve allergen reduction to some extent due to denaturation of the high-order structure of the allergen in albumen. However, in the extremely high pressure treatment, a high temperature treatment is difficult in view of safety of the apparatus, although it is difficult to achieve sufficient allergen reduction with a treatment at room temperature. In addition, the extremely high pressure treatment requires a complex and large apparatus, so that there is still plenty of room for improvement in production costs.

### SUMMARY OF THE INVENTION

The present invention is made to solve the aforementioned problems. An object of the present invention is to provide an allergen reduction method which can be carried out without the need for a large or complicated apparatus and which allows for reduction of an allergen content while maintaining the basic characteristics intrinsic to albumen, such as texture, a foaming property and foam stability, a method of producing allergen-reduced albumen with the reduced allergen content, a method of producing an allergen-reduced albumen composition with the reduced allergen content, and an allergen-reduced food product which is a food product containing the allergen-reduced albumen or a food product made of the allergen-reduced albumen composition.

The present invention relates to an allergen reduction method comprising a heating and pressurizing treatment in heated water vapor and/or hot water with a treatment pressure set in a range of 140 to 400 kPa and a treatment temperature set in a range of 110 to 150° C. to reduce a content of an allergen in albumen.

Preferably, in the allergen reduction method in accordance with the present invention, a treatment time of the heating and pressurizing treatment is set in a rage of 10 seconds to 8 minutes.

Preferably, in the allergen reduction method in accordance with the present invention, the allergen of which content is to be reduced includes ovomucoid.

Preferably, in the allergen reduction method in accordance with the present invention, the heating and pressurizing treatment is carried out in a sealed container.

The present invention also relates to a method of producing allergen-reduced albumen comprising subjecting albumen to a heating and pressurizing treatment in heated water vapor and/or hot water with a treatment pressure set in a range of 140 to 400 kPa and a treatment temperature set in a range of 110 to 150° C. whereby allergen-reduced albumen with a reduced content of an allergen in the albumen is obtained.

Preferably, in the method of producing allergen-reduced albumen in accordance with the present invention, the albumen is raw albumen or a dry albumen solution, and the raw albumen or the dry albumen solution has a moisture content in a range of 70 to 98% by mass.

The present invention also relates to a method of producing an allergen-reduced albumen composition comprising subjecting an albumen composition at least including albumen to a heating and pressurizing treatment in heated water vapor and/or hot water with a treatment pressure set in a range of 140 to 400 kPa and a treatment temperature set in a range of 110 to 150° C. whereby an allergen-reduced albumen composition with a reduced content of an allergen in the albumen composition is obtained.

The present invention also relates to an allergen-reduced food product which is a food product containing allergen-reduced albumen obtained by the method of producing allergen-reduced albumen as described above or a food product made of an allergen-reduced albumen composition obtained by the method of producing an allergen-reduced albumen composition as described above. Preferably, the allergen-reduced food product is baby food or an egg cookie.

In accordance with the present invention, an allergen content in albumen can be reduced without necessitating a complicated apparatus or treatment while the basic characteristics intrinsic to albumen, such as texture, a foaming property and foam stability are maintained. Allergen-reduced albumen, an allergen-reduced albumen composition, and an allergen-reduced food product with a significantly reduced allergen content can be obtained.

The resultant allergen-reduced albumen and allergen-reduced albumen composition in accordance with the present invention have the allergen content reduced enough with a basic characteristic intrinsic to albumen and may suitably be applied, for example, to a food product such as baby food, egg cookie (bolo), pudding, pot-steamed hotchpotch, or cake as well as cosmetics, chemicals, and the like.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a result of evaluation of an ovomucoid content in a resulting allergen-reduced food product 1 in Example 1 by indirect ELISA using a mouse IgG antibody.

FIG. 2 shows a result of measurement of an ovomucoid content in a resulting allergen-reduced food product 2 in Example 2 by indirect ELISA using a mouse IgG antibody.

FIG. 3 shows a result of measurement of an ovomucoid content in a resulting allergen-reduced food product 3, 4 in Example 3, 4 by indirect ELISA using a mouse IgG antibody.

FIG. 4 shows a result of measurement of an ovomucoid content in a resulting allergen-reduced food product 8 in Example 8 by indirect ELISA using a mouse IgG antibody.

FIG. 5 shows a result of measurements of ovomucoid contents in resulting comparative products 1-3 in Comparative Examples 1-3 by competitive inhibition ELISA using a mouse IgG antibody.

FIG. 6 shows a result of measurements of allergen contents in resulting allergen-reduced food products 4-7 in Examples 4-7 using FASTKIT.

FIG. 7 shows a result of measurement of an allergen content in resulting allergen-reduced food product 2 in Example 2 by ELISA using an IgE antibody of egg-allergic patient's serum.

FIG. 8 shows a result of measurement of an allergen content in resulting allergen-reduced food product 8 in Example 8 by ELISA using an IgE antibody of egg-allergic patient's serum.

FIG. 9 shows a result of evaluation of the foaming property of resulting allergen-reduced food product 2 in Example 2.

FIG. 10 shows a result of evaluation of foam stability of resulting allergen-reduced food product 2 in Example 2.

FIG. 11 shows a result of evaluation of shelf life of resulting allergen-reduced food product 2 in Example 2.

### DESCRIPTION OF THE PREFERRED EMBODIMENTS

In the present invention, an allergen content in albumen is reduced by performing a heating and pressurizing treatment on albumen or an albumen composition, in heated water vapor and/or hot water at a treatment pressure in the range of 140-400 kPa, and at a treatment temperature in the range of 110-150° C. In the present invention, albumen may be subjected to a heating and pressurizing treatment alone or albumen may be subjected to a heating and pressurizing treatment in a state in which it is mixed with any other component in a solid or liquid albumen composition. Typically, the heating and pressurizing treatment is preferably carried out in a state of raw albumen or in a state of a dry albumen solution including dry albumen dissolved into a solvent, for example, such as water.

Here, the above-noted raw albumen refers to albumen obtained by breaking a natural egg and separating albumen from yolk. Furthermore, the above-noted dry albumen refers to solid albumen which may be prepared, for example, by stirring albumen uniformly and dehydrating and freeze-drying the albumen using a freeze-drier.

In the present invention, albumen or an albumen composition (in the following, albumen and an albumen composition are also collectively referred to as an albumen inclusion) is subjected to a heating and pressurizing treatment in heated water vapor and/or hot water. In reducing an allergen by performing a heating treatment on an albumen inclusion, if a temperature difference occurs between the surface and the inside of the albumen inclusion, sufficient and uniform allergen reduction is hardly achieved. However, in the present invention, not only the surface but also the inside of an albumen inclusion is heated enough by heated water vapor and/or hot water. In other words, when an albumen inclusion is subjected to a heating and pressurizing treatment in hot water, the hot water reaches the treatment temperature in accordance with the present invention, so that the actual temperature of the inside of the albumen inclusion also presumably reaches the treatment temperature or a temperature in the vicinity thereof. On the other hand, when an albumen inclusion is subjected to a heating and pressurizing treatment in heated water vapor, even if the albumen inclusion undergoes the heating and pressurizing treatment in a solid state, the heated water vapor easily intrudes into the inside of the albumen because of the small molecule size. The heated water vapor which reaches the treatment temperature in accordance with the present invention intrudes into the inside of the albumen inclusion, so that the actual temperature of the inside of the albumen inclusion also presumably reaches the treatment temperature or a temperature in the vicinity thereof. In other words, in the present invention, denaturation caused by destruction of the high-order structure of protein molecule of the allergen in an albumen inclusion can proceed enough without excessively increasing a treatment pressure and a treatment temperature, thereby eliminating the need for a large or complicated apparatus. In addition, excessive denaturation of the protein molecule other than the allergen in albumen can be prevented to maintain the basic characteristics intrinsic to albumen, and a sufficient allergen-reduction effect can be achieved.

Furthermore, since ovalbumin and ovomucoid which are typical allergens in albumin are water-soluble, it is advantageous that a hydrophilic environment is formed because of the presence of heated water vapor and/or hot water around the allergen protein molecule, in that a hydrogen bond that forms a secondary structure, especially an a helix structure of protein molecule is easily broken.

When albumen subjected to a heating and pressurizing treatment in accordance with the present invention is supplied in a condition that it contains water, for example, raw albumen or dry albumen aqueous solution, the water in the albumen is heated during the heating and pressurizing treatment to become hot water, thereby allowing a heating and pressurizing treatment for the albumen in hot water. In this case, although it is not necessary to supply heated water vapor, heated water vapor may be supplied with hot water.

On the other hand, when an albumen inclusion to be heated and pressurized in accordance with the present invention is supplied in a condition that albumen is contained in an albumen inclusion made of a solid product, such as cake, heated water vapor is supplied to the surroundings of the solid product in a heating and pressurizing apparatus, thereby allowing a heating and pressurizing treatment of albumen in heated water vapor.

A treatment pressure of the heating and pressurizing treatment performed in the present invention is in the range of 140 to 400 kPa. The treatment pressure lower than 140 kPa is not preferable in that denaturation of the allergen protein molecule does not proceed enough. On the other hand, the treatment pressure higher than 400 kPa is not preferable in that denaturation of the protein molecule other than the allergen in albumen excessively proceeds and in that the production costs are excessively increased due to the increased size of an apparatus for heating and pressurizing treatment. The treatment pressure is preferably 170 kPa or higher, more preferably, 190 kPa or higher. Furthermore, the treatment pressure is preferably 300 kPa or lower, more preferably, 250 kPa or lower.

A treatment temperature of the heating and pressurizing treatment performed in the present invention is in the range of 110 to 150° C. The treatment temperature lower than 110° C. is not preferable in that denaturation of the allergen protein molecule does not proceed enough. On the other hand, the treatment temperature higher than 150° C. is not preferable in that the desired degree of basic characteristics intrinsic to albumen does not result due to excessive denaturation of the protein molecule other than the allergen in albumen. The treatment temperature is preferably 115° C. or higher, more preferably 118° C. or higher. Furthermore, the treatment temperature is preferably 140° C. or lower, more preferably 130° C. or lower, more preferably 125° C. or lower.

It is noted that the treatment pressure and the treatment temperature as described above are preferably the values of pressure and temperature actually applied to an albumen inclusion subjected to a heating and pressurizing treatment in the present invention. However, if the characteristic of an apparatus makes the measurement difficult, a setting pressure and a setting temperature in a heating and pressurizing apparatus may be permitted.

In the present invention, the treatment time of the heating and pressurizing treatment is preferably set at 10 seconds to 8 minutes. The treatment time of 10 seconds or longer is preferable in that denaturation of the allergen protein molecule proceeds well. The treatment time of 8 minutes or shorter is preferable in that excessive denaturation of the protein molecule other than the allergen in albumen is prevented and the basic characteristics intrinsic to albumen are maintained well. The treatment time is preferably 15 seconds or longer, more preferably 30 seconds or longer. Furthermore, the treatment time is preferably 5 minutes or shorter, more preferably 3 minutes or shorter, more preferably 2 minutes or shorter, and more preferably 1.5 minutes or shorter.

It is noted that in the heating and pressurizing treatment in accordance with the present invention, the heating and pressurizing treatment proceeds to some extent during the temperature rise from room temperature to a prescribed treatment temperature and also during the temperature drop from a prescribed treatment temperature to room temperature. For example, the temperature rise may require 20 to 30 minutes from room temperature to a treatment temperature, and the temperature drop may require 20 to 30 minutes from a treatment temperature to room temperature.

In the present invention, a moisture content of an albumen inclusion can be set in the range of 70 to 98% by mass. The moisture content of 70% or more by mass is preferable in that denaturation of the allergen protein molecule proceeds well due to sufficient supply of hot water into the albumen inclusion. The moisture content of 98% or less by mass is preferable in that the effect of the heating and pressurizing treatment can be brought about well due to a high solid concentration in the albumen inclusion, and in addition that the treated, allergen-reduced albumen inclusion is conveniently used, for example, in a food product. The moisture content is preferably 75% or more by mass, more preferably 80% or more by mass. Furthermore, the moisture content is preferably 95% or less by mass, more preferably 90% or less by mass.

It is noted that the moisture content of the albumen inclusion can be obtained by measuring the amount of solute included in a solution. The measurement method includes, for example, a heat drying method. In this method, a sample of about 2 to 3 g is placed on a weighing dish and weighed, then dried by a constant-temperature drier at 105° C. for 2 to 4 hours, left to cool for 30 to 60 minutes, and then weighed. As another known method, a moisture content may be measured by a small automatic moisture measuring apparatus using Karl Fischer method or near-infrared spectroscopy.

Allergens to be reduced in the present invention include ovomucoid, ovalbumin, and the like. In the present invention, reduction of an allergen content is possible while excessive denaturation of the protein molecule other than the allergen in albumen is prevented. Therefore, the present invention is preferably applied in particular to allergen reduction for ovomucoid which is heat-resistant and less digestible and in which allergy reduction is generally difficult.

The treatment pressure and the treatment temperature in the heating and pressurizing treatment in accordance with the present invention are controlled by setting a pressure and a temperature in a heating and pressurizing treatment apparatus in a prescribed range. The control of treatment pressure and treatment temperature can be carried out using a heating and pressurizing treatment apparatus at least including a heating mechanism and a pressurizing mechanism. Other than air, for example, an inert gas such as nitrogen, or the like may be employed as an ambient gas during the heating and pressurizing treatment.

In the present invention, it is particularly preferable that the heating and pressurizing treatment is carried out in a sealed container. More specifically, in the presence of liquid-state water in a sealed container, the temperature inside the container can be increased thereby increasing the pressure inside the container due to vaporization of water, and the like. Thus, the treatment pressure and the treatment temperature required for the heating and pressurizing treatment in accordance with the present invention can be obtained with a small and simple apparatus. Air, nitrogen or the like can be used as an ambient gas introduced into a sealed container before a heating and pressurizing treatment in the container. Furthermore, in preparation of a sealable container, initial conditions such as the container size, the amount of albumen inclusion, and the amount of water supply are preferably set so that heated water vapor can exist at a saturated vapor pressure in the container. When heated water vapor exists at a saturated vapor pressure in a container, denaturation of the allergen protein molecule proceeds better.

In the present invention, allergen reduction can be achieved such that an allergen content in allergen-reduced albumen or an allergen-reduced albumen composition is, for example, 10% or less, 5.0% or less, 2.0% or less, 1.0% or less of the allergen content in the albumen inclusion prior to the heating and pressurizing treatment. If an allergen content in allergen-reduced albumen or an allergen-reduced albumen composition is 10% or less of the allergen content in each albumen inclusion prior to the heating and pressurizing treatment, preferably, allergen reduction is achieved to such an extent that an intake as a food product by an egg-allergic patient is permitted.

It is noted that the allergen contents in albumen or an albumen composition before and after the heating and pressurizing treatment in the production method in accordance with the present invention can be calculated by measuring and comparing the allergen contents in albumen before and after the heating and pressurizing treatment under the same condition, for example, by a method using a FASTKIT series, FASTKIT Elisa Egg Kit (manufactured by Nippon Meat Packers, Inc.) in compliance with a test method according to Ministry of Health, Labor and Welfare, by a method using ELISA to determine the binding property with an IgE antibody of egg-allergic patient's serum, or the like.

Furthermore, when ovomucoid is particularly selected as an allergen to be reduced in accordance with the present invention, for example, using a mouse monoclonal antibody, by a method using ELISA to determine the binding property with a mouse IgG antibody, or the like, the contents of ovomucoid acting as an allergen, that is, undenatured ovomucoid with a high-order structure preserved, in albumen or an albumen composition before and after heating and pressurizing treatment can be measured and compared.

When the resultant allergen-reduced albumen in accordance with the present invention is contained in a food product, the allergen content as described above may be evaluated as an allergen content in the food product.

The allergen-reduced albumen resulting from the production method as described above can be contained, for example, in food products such as baby food, egg cookie, pudding, and cake as well as cosmetics, chemicals, and the like. Alternatively, a food product or the like made of an allergen-reduced albumen composition in accordance with the present invention may be prepared by preparing an albumen composition using albumen which does not undergo allergen reduction, and thereafter carrying out a heating and pressurizing treatment on the albumen composition. In the resultant allergen-reduced albumen in accordance with the present invention, an allergen content is reduced while the basic characteristics intrinsic to albumen are maintained, so that it is particularly preferable that the allergen-reduced albumen is contained in a food product, where a cooking property such as a foaming property and foam stability, and texture become better. A food product made of the allergen-reduced albumen composition in accordance with the present invention is preferable in that it has excellent texture.

### EXAMPLE

In the following, the present invention will be described in detail with reference to Examples. However, the present invention is not limited thereto.

### Analysis Example 1

Purified ovomucoid obtained by purification by alcohol fractionation was dissolved in a solution obtained by dissolving 0.15 M of NaCl in 0.01 M phosphate buffer solution (also referred to as PBS hereinafter) at pH 7.2, resulting in 1% by mass PBS solution of ovomucoid (also referred to as ovomucoid solution hereinafter). An ovomucoid solution bag obtained by enclosing, hermetically sealing and vacuum-sealing the ovomucoid solution in a polypropylene food film was put into a pressure cooker (a home pressure cooker manufactured by Matsushita Electric Works, Ltd., model number “SR-PM32 3.2L”, microprocessor-controlled type) (also simply referred to as pressure cooker hereinafter) for a heating and pressurizing treatment with a treatment temperature of 120° C. and a treatment time of 1 minute. The treatment pressure indicated by the display of the pressure cooker was 2.0 atmospheric pressure (202.650 kPa). In the heating and pressurizing treatment, it took 25 minutes for the internal temperature of the pressure cooker to rise from room temperature to a treatment temperature of 120° C. It took 25 minutes for the pressure in the pressure cooker to return to about 1 atmospheric pressure and for the lock of the pressure cooker to release. An analysis ovomucoid solution 1 was obtained by the method as described above.

### Secondary Structure of Ovomucoid

For the resultant analysis ovomucoid solution 1 and an ovomucoid solution before a heating and pressurizing treatment, the CD (circular dichroism) spectra were measured in a condition of the wavelength range of 185 to 250 nm using Spectro Polarimeter manufactured by Jasco Corporation (model number “J-720”). It was then found that the shapes of CD spectra were different. Then, the ratio between the a helix structure and the β sheet structure of ovomucoid at pH 7 was calculated by the spectral analysis where the a helix, the β sheet and the unordered structure total to 100%. In the analysis ovomucoid solution 1 after the heating and pressurizing treatment, the ratio of the a helix structure was 4.5% and the ratio of the β sheet structure was 55%. On the other hand, in the ovomucoid solution before the heating and pressurizing treatment, the ratio of the a helix structure was 13% and the ratio of the P sheet structure was 50%.

In other words, in the analysis ovomucoid solution 1, the ratio of the β sheet structure did not change while the ratio of the a helix structure was significantly reduced, as compared with the ovomucoid solution before the heating and pressurizing treatment. These results showed that the a helix structure of ovomucoid in the ovomucoid solution was destroyed by the heating and pressurizing treatment at 120° C. and 2.0 atmospheric pressure (202.650 kPa).

### Ovomucoid Content Measurement Using Mouse IgG Antibody

A supernatant sample as described later was prepared from each of the analysis ovomucoid solution 1 and the ovomucoid solution before the heating and pressurizing treatment, and the ovomucoid content was measured by indirect ELISA using a mouse IgG antibody by a method as described later. The ovomucoid content in 1 g of the analysis ovomucoid solution 1 was 0.099 mg, which showed a significant reduction from 2.028 mg of the ovomucoid content in 1 g of the ovomucoid content before the heating and pressurizing treatment.

In other words, according to these results, it can be assumed that the heating and pressurizing treatment of the ovomucoid solution at the treatment pressure and the treatment temperature in the present invention causes denaturation of ovomucoid due to the destruction of the a helix structure, and the denaturation contributes to a reduction of content of undenatured ovomucoid which acts as an allergen. Based on these results, the following examples and comparative examples were examined.

### Example 1

### Dry Albumen

A 0.1 g/ml solution of dry albumen in water was used as albumen. In other words, the moisture content of the albumen is 90% by mass. It is noted that the dry albumen for use was prepared by sufficiently stirring and freezing raw albumin at −30° C.

An albumen bag was prepared by enclosing and vacuum-sealing 0.5 g of the above-noted albumen in a polypropylene food film (Dai Nippon Printing Co., Ltd.). The albumen bag was put into the pressure cooker for a heating and pressurizing treatment with a treatment temperature of 120° C. and a treatment time of 1 minute. The treatment pressure in this example was 2.0 atmospheric pressure (202.650 kPa). It is noted that in the heating and pressurizing treatment in this example, it took 25 minutes for the internal temperature of the pressure cooker to rise from room temperature to the treatment temperature of 120° C., and it took 25 minutes for the internal pressure of the pressure cooker to return to about 1 atmospheric pressure and for the lock of the pressure cooker to release. Allergen-reduced food product 1 made of allergen-reduced albumen was obtained by the foregoing method.

Allergen-reduced food product 1 taken out of the food film was in such a state that liquid and solid were mixed, and was not completely solidified.

After 5 g of allergen-reduced food product 1 was suspended in PBS 10 ml, a homogenization treatment for 10 seconds was repeated three times using a homogenizer. Then, through centrifugal separation at 10000 rpm for 30 minutes, a supernatant sample 1 resulted. For supernatant sample 1, indirect ELISA was performed using a mouse IgG antibody by a method described later.

### Example 2

### Raw Albumen

The preparation and the heating and pressurizing treatment of an albumen bag were carried out in a similar method as in Example 1 except that raw albumen with a moisture content of 90% by mass was used as albumen. In the heating and pressurizing treatment in this example, the treatment temperature was 120° C., the treatment time was 1 minute, and the treatment pressure was 2.0 atmospheric pressure (202.650 kPa). It is noted that in the heating and pressurizing treatment in this example, it took 25 minutes for the internal temperature of the pressure cooker to rise from room temperature to the treatment temperature of 120° C., and it took 25 minutes for the internal pressure of the pressure cooker to return to about 1 atmospheric pressure and for the lock of the pressure cooker to release. Allergen-reduced food product 2 made of allergen-reduced albumen was obtained by the foregoing method.

Allergen-reduced food product 2 taken out of the food film was in such a state that liquid and solid were mixed, and was not completely solidified. For allergen-reduced food product 2, the foaming property, foam stability, and shelf life were evaluated.

Supernatant sample 2 was obtained from allergen-reduced food product 2 in a similar method as in Example 1. For supernatant sample 2, the ovomucoid content was measured by indirect ELISA using a mouse IgG antibody and the allergen content was measured by indirect ELISA using an IgE antibody of an egg-allergic patient's serum, by a method as described later.

### Example 3

### Boiled Egg

A boiled egg was used as an albumen composition, which contained 24% by mass of raw albumen having a moisture content of 90% by mass and had a moisture content of 76% by mass. Here, 5/4 cup (250 ml) of water was poured in the pressure cooker and the albumen composition was put onto a steam plate placed therein. Then, a heating and pressurizing treatment was carried out with a treatment temperature of 113° C. and a treatment time of 1 minute. The treatment pressure in the heating and pressurizing treatment in this example was 1.6 atmospheric pressure (162.12 kPa). It is noted that in the heating and pressurizing treatment in this example, it took 20 minutes for the internal temperature of the pressure cooker to rise from room temperature to the treatment temperature of 113° C., and it took 20 minutes for the internal pressure of the pressure cooker to return to about 1 atmospheric pressure and for the lock of the pressure cooker to release. A boiled egg as allergen-reduced food product 3 made of an allergen-reduced albumen composition was obtained by the foregoing method.

Supernatant sample 3 was obtained from allergen-reduced food product 3 in a similar method as in Example 1. For supernatant sample 3, the ovomucoid content was measured by indirect ELISA using a mouse IgG antibody by a method described later.

### Example 4

### Boiled Egg

A heating and pressurizing treatment was carried out in a similar method as in Example 3 except that the treatment temperature was set at 120° C. It is noted that the treatment pressure in the heating and pressurizing treatment in this example was 2.0 atmospheric pressure (202.650 kPa). It is noted that in the heating and pressurizing treatment in this example, it took 25 minutes for the internal temperature of the pressure cooker to rise from room temperature to the treatment temperature of 120° C., and it took 25 minutes for the internal pressure of the pressure cooker to return to about 1 atmospheric pressure and for the lock of the pressure cooker to release. A boiled egg as allergen-reduced food product 4 made of an allergen-reduced albumen composition was obtained by the foregoing method.

Supernatant sample 4 was obtained from allergen-reduced food product 4 in a similar method as in Example 1. For supernatant sample 4, the allergen content was measured using a FASTKIT series, FASTKIT Elisa Egg Kit (also referred to as FASTKIT) and the ovomucoid content was measured by indirect ELISA using a mouse IgG antibody by a method described later.

### Example 5

### Pudding

Pudding was used as an albumen composition, which contained 27% by mass of raw albumen having a moisture content of 90% by mass and had a moisture content of 86% by mass. Here, 5/4 cup (250 ml) of water was poured in the pressure cooker and the albumen composition was put onto a steam plate placed therein. Then, a heating and pressurizing treatment was carried out with a treatment temperature of 120° C. and a treatment time of 1 minute. The treatment pressure in the heating and pressurizing treatment in this example was 2.0 atmospheric pressure (202.650 kPa). It is noted that in the heating and pressurizing treatment in this example, it took 25 minutes for the internal temperature of the pressure cooker to rise from room temperature to the treatment temperature of 120° C., and it took 25 minutes for the internal pressure of the pressure cooker to return to about 1 atmospheric pressure and for the lock of the pressure cooker to release. Pudding as allergen-reduced food product 5 made of an allergen-reduced albumen composition was obtained by the foregoing method.

Supernatant sample 5 was obtained from allergen-reduced food product 5 in a similar method as in Example 1. For supernatant sample 5, the allergen content was measured using FASTKIT by a method described later.

### Example 6

### Pot-steamed Hotchpotch

Pot-steamed hotchpotch was used as an albumen composition, which contained 16% by mass of raw albumen having a moisture content of 90% by mass and had a moisture content of 96% by mass. Here, 5/4 cup (250 ml) of water was poured in the pressure cooker and the albumen composition was put onto a steam plate placed therein. Then, a heating and pressurizing treatment was carried out with a treatment temperature of 120° C. and a treatment time of 2 minutes. The treatment pressure in the heating and pressurizing treatment in this example was 2.0 atmospheric pressure (202.650 kPa). It is noted that in the heating and pressurizing treatment in this example, it took 25 minutes for the internal temperature of the pressure cooker to rise from room temperature to the treatment temperature of 120° C., and it took 25 minutes for the internal pressure of the pressure cooker to return to about 1 atmospheric pressure and for the lock of the pressure cooker to release. Pot-steamed hotchpotch as allergen-reduced food product 6 made of an allergen-reduced albumen composition was obtained by the foregoing method.

Supernatant sample 6 was obtained from allergen-reduced food product 6 in a similar method as in Example 1. For supernatant sample 6, the allergen content was measured using FASTKIT by a method described later.

### Example 7

### Cake

Cake was used as an albumen composition, which contained 29% by mass of raw albumen having a moisture content of 90% by mass and had a moisture content of 27% by mass. Here, 5/4 cup (250 ml) of water was poured in the pressure cooker and the albumen composition was put onto a steam plate placed therein. Then, a heating and pressurizing treatment was carried out with a treatment temperature of 120° C. and a treatment time of 7 minutes. The treatment pressure in the heating and pressurizing treatment in this example was 2.0 atmospheric pressure (202.650 kPa). It is noted that in the heating and pressurizing treatment in this example, it took 25 minutes for the internal temperature of the pressure cooker to rise from room temperature to the treatment temperature of 120° C., and it took 25 minutes for the internal pressure of the pressure cooker to return to about 1 atmospheric pressure and for the lock of the pressure cooker to release. Cake as allergen-reduced food product 7 made of an allergen-reduced albumen composition was obtained by the foregoing method.

Supernatant sample 7 was obtained from allergen-reduced food product 7 in a similar method as in Example 1. For supernatant sample 7, the allergen content was measured using FASTKIT by a method described later.

### Example 8

### Egg Cookie

The following ingredients including an allergen-reduced albumen which is allergen-reduced food product 1 obtained in Example 1 were mixed in the ordinal method and heated for 6 minutes at 160° C. in an oven which was preliminarily heated at 160° C. for 1 minute, resulting in an egg cookie which is allergen-reduced food product 8 containing allergen-reduced albumen.

| Ingredients | | |
|---|---|---|
| Starch | 50 | g |
| Flour | 10 | g |
| Sugar | 25 | g |
| Allergen-reduced Food 1 | 7 | g |
| Egg Yolk | 3 | g |
| Baking Powder | 0.5 | g |

After 5 g of allergen-reduced food product 8 was suspended in PBS 15 ml, a homogenization treatment at 9000 rpm for 10 seconds was repeated six times using a homogenizer. Thereafter, room temperature rotational extraction was carried out at 10 rpm for 1 hour. Then, through centrifugal separation at 4° C. and 10000 rpm for 30 minutes, supernatant sample 8 resulted. Furthermore, the precipitate resulting from the centrifugal separation was subjected to pepsin treatment, resulting in a pepsin digest. The pepsin treatment was carried out by adding hydrochloric acid 10 ml of 0.05 N to the precipitate with addition of pepsin 0.2 g to cause reaction at 37° C. for 5 hours. After the end of reaction, centrifugal separation was carried out at 4° C. and 10000 rpm for 30 minutes, and 1 ml of the resultant supernatant was neutralized with addition of 100 μl of 1M Tris.

For each of supernatant sample 8 and the pepsin digest, the ovomucoid content was measured by indirect ELISA using a mouse IgG antibody and the allergen content was measured by indirect ELISA using an IgE antibody of an egg-allergic patient's serum. Then, the sum of the measurement values of supernatant sample 8 and the pepsin digest was determined as the ovomucoid content or the allergen content of allergen-reduced food product 8.

### Comparative Example 1

### Heating Treatment for Dry Albumen Solution

PBS solution 8 ml of 10% by mass of dry albumen was subjected to a heating treatment using an oven at 170° C. for 30 minutes, resulting in comparative product 1. Furthermore, comparative supernatant sample I was obtained from comparative product 1 in a similar method as in Example 1. For comparative supernatant sample 1, the ovomucoid content was measured by competitive inhibition ELISA using a mouse IgG antibody.

### Comparative Example 2

### Steam Treatment for Dry Albumen Solution

PBS solution 8 ml of 10% by mass of dry albumen was subjected to a steam treatment on a boiling bath for 30 minutes, resulting in comparative product 2. Furthermore, comparative supernatant sample 2 was obtained from comparative product 2 in a similar method as in Example 1. For comparative supernatant sample 2, the ovomucoid content was measured by competitive inhibition ELISA using a mouse IgG antibody.

### Comparative Example 3

### Pressurizing Treatment for Dry Albumen Solution

PBS solution 8 ml of 10% by mass of dry albumen was put into a food pressurizing apparatus manufactured by Mitsubishi Heavy Industries Ltd. (model number “MFP-7000”) for a pressurizing treatment with a setting pressure of 686 Mpa at 20° C. for 30 minutes, resulting in comparative product 3. Furthermore, comparative supernatant sample 3 was obtained from comparative product 3 in a similar method as in Example 1. For comparative supernatant sample 3, the ovomucoid content was measured by competitive inhibition ELISA using a mouse IgG antibody.

It is noted that in each evaluation using FASTKIT, mouse IgG antibody, IgE antibody, individual measurements were conducted under the same conditions, where a 0.1 g/ml solution of dry albumen in water, raw albumen, an albumen composition before a heating and pressurizing treatment in each example, and a commercially-available egg cookie were used as controls for allergen-reduced food product 1, allergen-reduced food product 2 and comparative products 1-3, allergen-reduced food products 3-7, and allergen-reduced food product 8, respectively.

### Evaluation Method

### Allergen Content

For the resultant supernatant samples as described above, the allergen contents were measured by the following methods. It is noted that, in the following measurement, approximately the whole amount of allergen to be reduced in accordance with the present invention is assumed to be present in each of the supernatant samples as described above, for the typical allergen in albumen is water-soluble.

1. Allergen Content Measurement Using FASTKIT

For the resultant supernatant samples as described above, the aforementioned FASTKIT Egg Kit in compliance with the test method according to Ministry of Health, Labor and Welfare was used to measure the allergen content in each supernatant sample. It is noted that FASTKIT is a known kit to evaluate an allergen content in a sample based on a degree of binding of a polyclonal antibody with a variety of known allergens, and Egg Kit is a kit to detect a variety of known allergens in albumen such as ovomucoid and ovalbumin with an absorbance of 450 nm.

2. Ovomucoid Content Measurement by Ovomucoid Antibody (Mouse IgG Antibody)

For the resultant supernatant samples as described above, a mouse monoclonal antibody to ovomucoid was used to measure the ovomucoid content having antigencity in each supernatant by indirect ELISA or competitive inhibition ELISA.

Preparation of Mouse Monoclonal Antibody

After cloning a fusion cell of a mouse spleen cell immunized against ovomucoid and myeloma, an ovomucoid antibody-producing cell 4-8D was injected into the abdominal cavity of a mouse, and the abdominal dropsy was then obtained. The obtained abdominal dropsy was centrifuged at 3000 rpm for 20 minutes. Thereafter, ammonium sulfate was added to the supernatant of the abdominal dropsy until saturation, and protein was precipitated using salting-out, followed by centrifugal separation at 13000 rpm for 15 minutes. The resulting precipitate was dissolved in PBS for dialysis. Thus, a mouse monoclonal antibody OMmAb (4-8D) (also simply referred to as OMmAb (4-8D) hereinafter) was obtained.

(1) Indirect ELISA

The resultant supernatant as described above was added as an antigen protein to an assay plate (manufactured by IWAKI) by 100 μl/well and let to be absorbed overnight at 4° C. to form an antigen absorbed plate. After the antigen absorbed plate was washed three times by 200 μl/well of PBS including 0.05% Tween 20 (referred to as PBS-T hereinafter), PBS including 1% of BSA (bovine serum albumin) was added by 150 μl/well, and blocking was conducted at room temperature for 1 hour. This was washed again by PBS-T three times.

OMmAb (4-8D) of 1 μg/ml was added as a primary antibody by 100 μl/well to the resultant plate as described above and shaken at room temperature for 2 hours to be absorbed, followed by washing by PBS-T three times. Next, a 1000-fold dilution of peroxidase-labeled goat anti-mouse IgG antibody as a secondary antibody was added by 100 μl/well and shaken at room temperature for 2 hours to be absorbed. Thereafter, the plate was washed by PBS-T three times. A reaction matrix made of 0.1M sodium citrate buffer solution (pH 5.0) including 1% by mass of Υ-phenylenediamine H₂O₂ was added by 100 μl/well to cause reaction at room temperature for 10 minutes. The reaction was stopped by stopping color development with addition of 2M H₂SO₄ by 100 μl/well, and an absorbance at 490 nm was measured.

At the same time, standard solutions having ovomucoid concentrations 10 μg/ml, 5 μg/ml, 1 μg/ml, 0.5 μg/ml, 0.1 μg/ml, 0.0 μg/ml were prepared, which were prepared by dissolving purified ovomucoid obtained by purification by alcohol fractionation method into PBS, and the similar operation as described above were performed to measure absorbances. A standard curve was created based on the absorbance values of the standard solutions, and based on this standard curve, the concentration of ovomucoid that reacted with OMmAb (4-8D) was calculated. Then, the ovomucoid content in 1 g of each of allergen-reduced food products 2-4, allergen-reduced food product 8 and the controls thereof was calculated.

(2) Competitive Inhibition ELISA

Ovomucoid of 10 μg/ml was added to an assay plate (manufactured by IWAKI) by 100 μl/well, left at 4° C. overnight to be absorbed to form an antigen absorbed plate. After the antigen absorbed plate was washed by PBS-T 200 μl/well three times, PBS including 1% of BSA was added by 150 μl/well, and blocking was conducted at room temperature for 1 hour. This was washed again by PBS-T three times.

Then, 0.1 ml of 1 μg/ml OMmAb (4-8D) as a primary antibody was poured into each of six microtubes, and 0 μl, 5 μl, 10 μl, 15 μl, 20 μl, 30 μl of supernatant samples were each added and mixed in each microtube to cause reaction for 1 hour. Then, 100 μl is added from each of the microtubes into a well and shaken at room temperature for 2 hours to be absorbed. Thereafter, washing by PBS-T was carried out three times.

Then, a 1000-fold dilution of peroxidase-labeled goat anti-mouse IgG antibody as a secondary antibody was added by 100 μl/well and shaken at room temperature for 2 hours to be absorbed. Thereafter, washing by PBS-T was performed three times, and a reaction matrix made of 0.1 M sodium citrate buffer solution (pH 5.0) including 1% by mass of Υ-phenylenediamine H₂O₂ was added by 100 μl/well to cause reaction at room temperature for 10 minutes. The reaction was stopped by stopping color development with addition of 2M H₂SO₄ by 100 μl/well, and an absorbance at 490 nm was measured. The absorbance was shown in the form of relative absorbance where the absorbance obtained when 0.1 ml of OMmAb (4-8D) at a concentration of 1 μg/ml was reacted with 0.015 ml PBS including no antigen was 1.

3. Allergen Content Measurement Using IgE Antibody of Egg-allergic Patient's Serum

Except that an IgE antibody of an egg-allergic patient's serum was used as a primary antibody and anti-Human IgE-HRP (horseradish peroxidase) labeled antibody was used as a secondary antibody, the similar operation as indirect ELISA as described above was performed on the resultant supernatant as described above. It is noted that the serum of an infant patient diagnosed as having an egg allergy was provided as the above-noted IgE antibody. The patients were 33 egg-allergic children with informed consent from their parents, ranging from a four-month baby to a three-year-and-four-month old child.

In this Example, a calibration curve was created in the following manner to obtain an allergen content detected by indirect ELISA using an IgE antibody. First, standard solutions having ovomucoid concentrations 10 μg/ml, 5 μg/ml, 1 μg/ml, 0.5 μg/ml, 0.1 μg/ml, 0.0 μg/ml were prepared, which were prepared by dissolving purified ovomucoid obtained by purification by alcohol fractionation method into PBS. For these standard solutions, indirect ELISA was performed using IgE antibody through the similar operation as described above to measure absorbances. Then, a calibration curve was created where the axis of abscissas indicates ovomucoid concentrations and the axis of ordinates indicate the values of absorbance.

Then, for supernatant sample 2, supernatant sample 8, and the pepsin digest of Example 8, the sample absorbance was measured by carrying out indirect ELISA using an IgE antibody. Then, the ovomucoid concentration was read from the absorbance corresponding to the sample absorbance on the calibration curve. Since it is well known that ovomucoid is a major allergen, assuming that the ovomucoid concentration corresponding to the sample absorbance was an allergen concentration, the allergen content was calculated.

### Basic Characteristics

The foaming property, foam stability and shelf life were evaluated as the basic characteristics of the allergen-reduced albumen. The allergen-reduced albumen which is the resulting allergen-reduced food product 2 in Example 2 was suspended in PBS 10 ml and homogenized at 9000 rpm for 4 minutes using a homogenizer. The foaming property and the foam stability of the albumen foam formed by homogenization were evaluated by the following method.

1. Foaming Property

A petri dish of which mass was measured beforehand was filled with the albumen foam resulting from the aforementioned method, and then the mass of the petri dish filled with the albumen foam was measured. Besides, the same petri dish as used above was filled with water, and its mass was measured. Based on these masses, the specific gravity of the albumen foam was calculated according to the following equation:

(the specific gravity of the albumen foam)=(the mass of the petri dish filled with the albumen foam (g)−the mass of the petri dish alone (g))/(the mass of the petri dish filled with water (g)−the mass of the petri dish alone (g)). The smaller specific gravity of the albumen foam suggests the higher foaming property of the allergen-reduced albumen.

2. Foam Stability

The albumen foam resulting from the aforementioned method was put into a funnel with filter paper, so that the albumen foam dropped from the funnel. The amount of droppings in the period of 20 minutes was measured, and the dropping speed of the albumen foam was measured according to the following equation:

(the dropping speed)=(the amount of droppings of the albumen foam during 20 minutes (g))/(the mass of the albumen foam put into the funnel (g)). The slower dropping speed suggests the higher foam stability.

3. Shelf Life

The allergen-reduced albumen which is allergen-reduced food product 2 was enclosed in a polypropylene food film (Dai Nippon Printing Co., Ltd.) and stored in a dark place, that is, in a refrigerator at 4° C. for 1 week, for 1 month, 2 months, and 5 months each. The foaming property and the foam stability of the allergen-reduced albumen after storage were evaluated. The foaming property was evaluated by calculating the specific gravity of the albumen foam in the similar method as described above. As for the foam stability, the albumen foam was put into a funnel with filter paper so that the albumen foam dropped from the funnel, and then based on the amount of droppings after 2 minutes,

(value A)=(the amount of droppings of the albumen foam during 2 minutes (g))/(the mass of the albumen foam filled in the funnel (g)) was calculated. The foam stability was evaluated according to

(foam stability evaluation value)=1/((value A)/(elapsed time (2 minutes))). The higher foam stability evaluation value suggests the higher foam stability.

### Evaluation Result

### Ovomucoid Content Measurement Using Mouse IgG Antibody

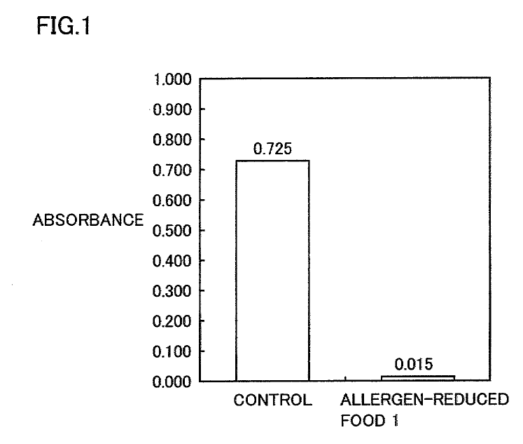

As shown in FIG. 1, the absorbance in allergen-reduced food product 1 is 0.015. Compared with the absorbance 0.725 of the 0.1 g/ml solution of the control dry albumen in water, the absorbance is significantly reduced, which suggests that the ovomucoid content of allergen-reduced food product 1 is reduced.

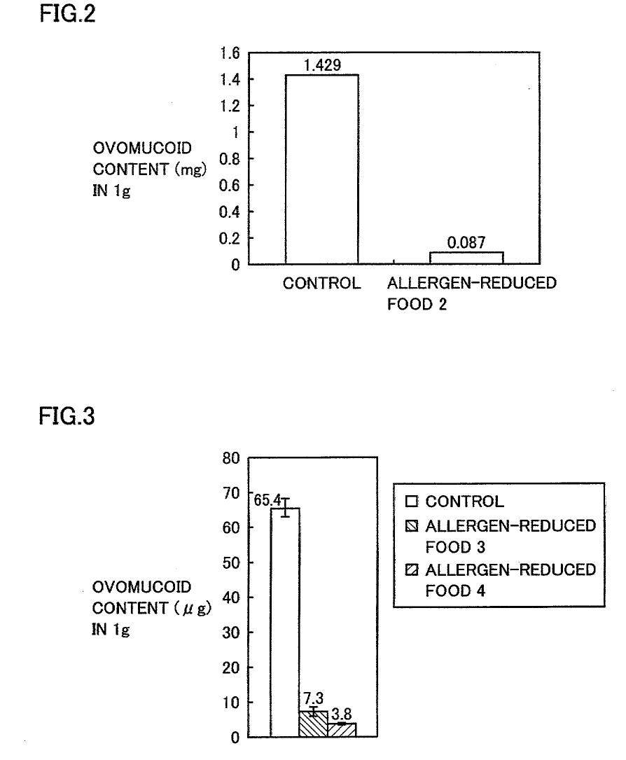

As shown in FIG. 2, the ovomucoid content in 1 g of allergen-reduced food product 2 is 0.087 mg. It can be understood that as compared with the ovomucoid content of 1.429 mg of the control raw albumen, the ovomucoid content is significantly reduced.

As shown in FIG. 3, the ovomucoid contents in 1 g of allergen-reduced food products 3, 4 are 7.3 μg, 3.8 μg, respectively. It can be understood that as compared with the ovomucoid content of 65.4 μg in 1 g of the control albumen composition, the ovomucoid content is significantly reduced.

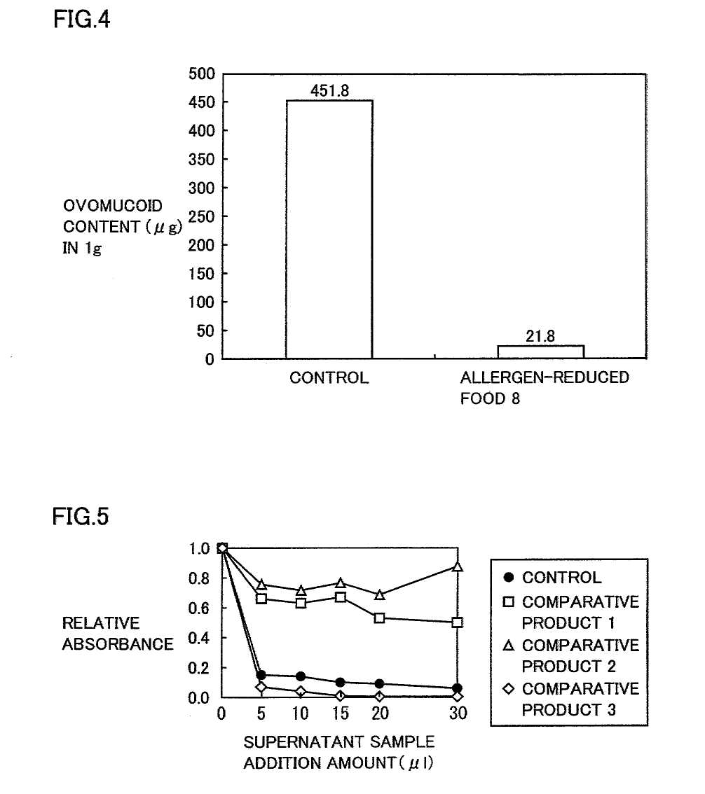

As shown in FIG. 4, the ovomucoid content in 1 g of allergen-reduced food product 8 is 21.8 μg. It can be understood that as compared with the ovomucoid content of 451.8 μg in 1 g of the control commercially-available cookie, the ovomucoid content is significantly reduced.

As shown in FIG. 5, while the ovomucoid contents in comparative products 1, 2 were reduced as compared with the control raw albumen, the ovomucoid content in comparative product 3 was not reduced. Furthermore, in comparative product 1, the ovomucoid content was only reduced to about 30 to 50% of the control raw albumen. Also in comparative product 2, the ovomucoid content was only reduced to about 50 to 70% of the control raw albumen. Although each example and each comparative example in the present specification were evaluated in different methods and thus cannot be compared with each other directly, the comparison with the control raw albumen indicates that the heating and pressurizing treatment in accordance with the present invention is noticeably superior to the heating treatment, the steam treatment or the pressurizing treatment as in Comparative Examples 1-3.

The aforementioned results show that the allergen-reducing effect according to the present invention is noticeably brought about even for ovomucoid, which is heat-resistant and less digestible and in which allergen reduction is generally difficult. Moreover, when albumen is subjected to a heating and pressurizing treatment in a state of dry albumen solution or raw albumen, the better allergen-reducing effect can be achieved as compared with a heating and pressurizing treatment in a state of food product.

### Allergen Content Measurement by FASTKIT

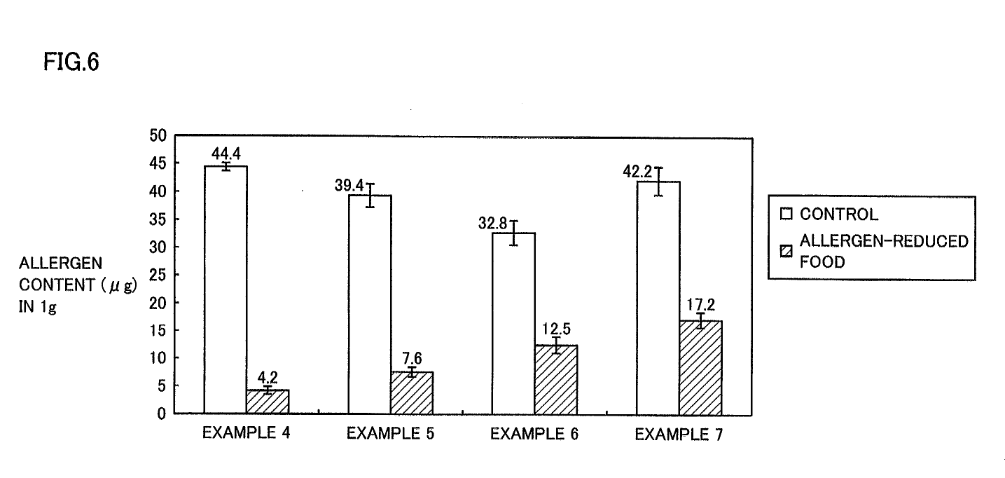

As shown in FIG. 6, the allergen contents in 1 g of allergen-reduced food products 4 to 7 are 4.2 μg, 7.6 μg, 12.5 μg, 17.2 μg, respectively. It can be understood that the allergen contents are significantly reduced as compared with the allergen contents of 44.4 μg, 39.4 μg, 32.8 μg, 42.2 μg in 1 g of the respective control albumen compositions.

This result shows that in accordance with the present invention, the allergen-reducing effect for the allergen in albumen can be brought about noticeably.

Allergen Content Measurement Using IgE Antibody of Egg-Allergic Patient's Serum

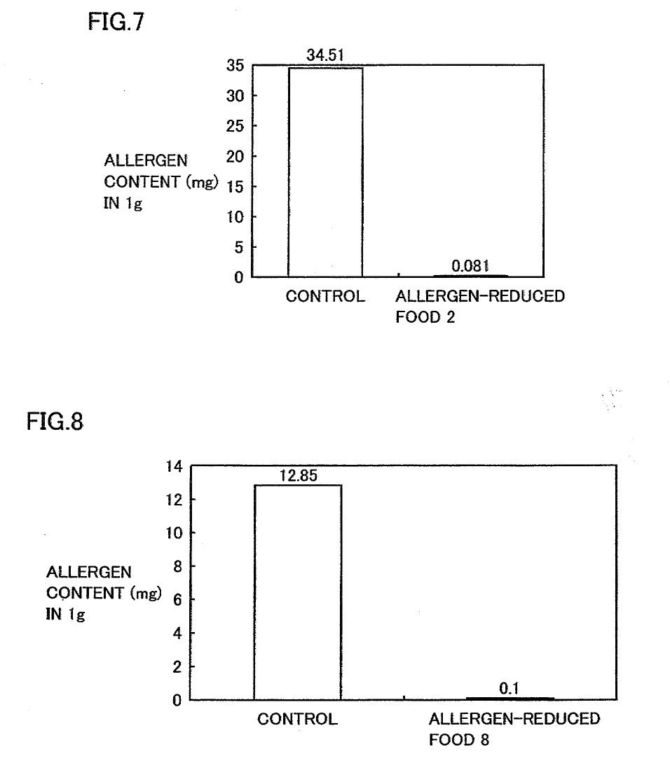

As shown in FIG. 7, the allergen content in 1 g of allergen-reduced food product 2 is 0.081 mg. It can be understood that the allergen content is significantly reduced as compared with the allergen content of 34.51 mg in 1 g of the control raw albumen.

As shown in FIG. 8, the allergen content in 1 g of allergen-reduced food product 8 is 0.1 mg. It can be understood that the allergen content is significantly reduced as compared with the allergen content of 12.85 mg in 1 g of the control, commercially-available cookie.

The aforementioned results show that in accordance with the present invention, the allergen-reducing effect for the allergen in albumen can be brought about noticeably. Moreover, when albumen is subjected to a heating and pressurizing treatment in particular in a state of raw albumen, the better allergen-reducing effect can be achieved as compared with a heating and pressurizing treatment in a state of food product.

### Foaming Property

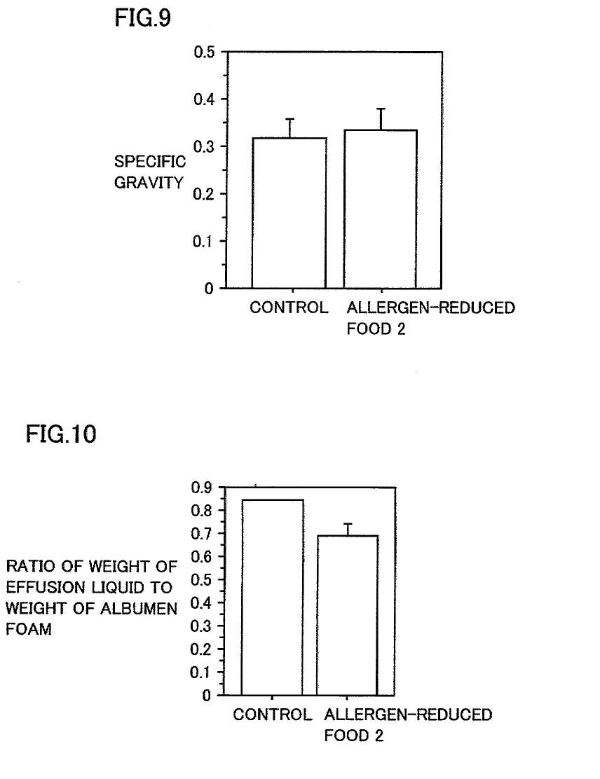

As shown in FIG. 9, the specific gravity of the albumen foam prepared from the allergen-reduced albumen that is allergen-reduced food product 2 is approximately equal to that of the albumen foam prepared from the control raw albumen. It can be understood that allergen-reduced food product 2 has a good foaming property.

### Foam Stability

The axis of ordinates in FIG. 10 indicates the ratio of the weight of the effusion liquid to the weight of the albumen foam based on the dropping speed of albumen foam. As shown in FIG. 10, the foam stability of the albumen foam prepared from the allergen-reduced albumen that is allergen-reduced food product 2 is slightly lower but not so different from the foam stability of the albumen foam prepared from the control raw albumen. It can be understood that allergen-reduced food product 2 has good foam stability.

### Shelf Life

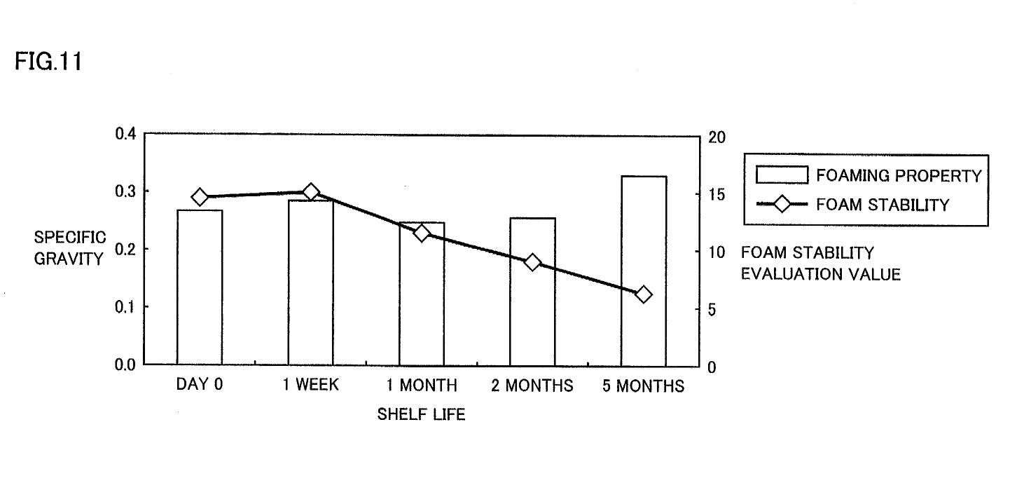

As shown in FIG. 11, the shelf life of the albumen foam prepared from the allergen-reduced albumen that is allergen-reduced food product 2 is good up to five months.

### Texture

Allergen-reduced food products 1 to 8 were tasted to find good texture.

The results as described above show that in the resultant allergen-reduced albumen or allergen-reduced albumen composition in accordance with the present invention, the basic characteristics intrinsic to albumen, such as texture, foaming property, foam stability are well maintained, while the allergen content is significantly reduced. In particular, when albumen is subjected to a heating and pressurizing treatment in the state of raw albumen or dry albumen solution, the allergen content reducing effect can be brought about well.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An allergen-reduced food product containing allergen-reduced albumen obtained by a method of producing allergen-reduced albumen which comprises subjecting albumen to a heating and pressurizing treatment in heated water vapor and/or hot water with a treatment pressure set in a range of 140 to 400 kPa and a treatment temperature set in a range of 110 to 150° C. whereby allergen-reduced albumen with a reduced content of an allergen in said albumen is obtained.

2. The allergen-reduced food product according to claim 1, wherein the allergen-reduced food product is baby food.

3. The allergen-reduced food product according to claim 1, wherein the allergen-reduced food product is an egg cookie.

4. An allergen-reduced food product made of an allergen-reduced albumen composition obtained by a method comprising subjecting an albumen composition at least including albumen to a heating and pressurizing treatment in heated water vapor and/or hot water with a treatment pressure set in a range of 140 to 400 kPa and a treatment temperature set in a range of 110 to 150° C. whereby an allergen-reduced albumen composition with a reduced content of an allergen in said albumen composition is obtained.

5. The allergen-reduced food product according to claim 4, wherein the allergen-reduced food product is baby food.

6. The allergen-reduced food product according to claim 4, wherein the allergen-reduced food product is an egg cookie.
